(19) United States
(12) Patent Application Publication
(10) Pub. No.: US 2013/0171295 A1
(43) Pub. Date: Jul. 4, 2013

(54) CONFECTIONERY AND METHODS OF PRODUCTION THEREOF

(71) Applicants: Sarah Marshall, West Berkshire (GB); Peter Clarke, Berkshire (GB); Devang Sutaria, Landing, NJ (US); Miles Van Niekerk, Madison, NJ (US)

(72) Inventors: Sarah Marshall, West Berkshire (GB); Peter Clarke, Berkshire (GB); Devang Sutaria, Landing, NJ (US); Miles Van Niekerk, Madison, NJ (US)

(21) Appl. No.: 13/583,304

(22) PCT Filed: Mar. 23, 2011
(86) PCT No.: PCT/GB2011/050588

§ 371 Date: Nov. 15, 2012

Related U.S. Application Data
(60) Provisional application No. 61/316,473, filed on Mar. 23, 2010.

(30) Foreign Application Priority Data
Mar. 23, 2010 (GB) 1004901.3

(51) Int. Cl. A23G 3/54; A23G 4/20

(52) U.S. Cl. CPC A23G 3/54; A23G 4/20
USPC 426/5; 426/103; 426/249

(57) ABSTRACT

A confectionery product comprises an extruded body portion having a plurality of conduits disposed therein. The extruded body portion is substantially transparent, the conduits contain a visually contrasting material, and different conduits comprise different colored substances and/or comprise substances which may vary in colour along the length of the conduits. The visually contrasting material in the conduits can comprise a reflective material and/or a luminescent material and/or a material which is able to change colour upon variations in pH and/or temperature. Methods of producing the confectionery product are also described.

### TECHNICAL FIELD OF THE INVENTION

The present invention relates to confectionery products and to a method of production thereof. In particular, the invention relates to confectionery products comprising one or a plurality of conduits disposed therein which may contain a visually contrasting material to the confectionery body.

It is desirable to produce confectionery products formed of different components, so as to increase sensory pleasure for a consumer. A number of confectionery products exist which have, for example, a flavoured liquid or syrup centre which is released upon chewing.

For example, WO 2007/056685 discloses an apparatus and method for the continuous production of centre-filled confectionery products in the form of a continuous extrudate having a plurality of centre-filled confectionery ropes. Whilst a product formed from such an apparatus does increase sensory pleasure, the period of pleasure is often short lived as the centre-fill is released quickly and/or degraded. It is therefore an object of the present invention to provide a confectionery product which can release a centre-fill over an extended period of time, and which provides a novel and/or improved visual and/or taste sensation for a consumer.

Further, there is demand for confectionery products having improved visual appearance whilst maintaining flavour. It is thus a further object of the present invention to provide a confectionery product which is eye-catching whilst still providing a desirable flavour.

There is also a demand for providing confectionery products having a reduced fat or sugar content. It is thus an object of the present invention to provide a confectionery product which can be produced having a lowered fat or sugar content, whilst still maintaining an excellent sensory pleasure.

Yet further there is demand for confectionery products having improved convenience whilst maintaining or improving flavour. It is thus a further object of the invention to provide a confectionery product which increases convenience whilst still maintaining, or even improving, flavour.

### SUMMARY OF THE INVENTION

Therefore, according to a first aspect of the present invention, there is provided a confectionery product comprising an extruded body portion, the extruded body portion comprising a plurality of conduits disposed therein, wherein the extruded body portion is substantially transparent and the plurality of conduits contain a visually contrasting material to the extruded body portion, wherein different conduits individually comprise different coloured substances and/or comprise substances which may vary in colour along the length of the conduits.

According to a second aspect of the present invention, there is provided a confectionery product comprising an extruded body portion, the extruded body portion comprising one or more conduits disposed therein, wherein the extruded body portion is substantially transparent and the one or more conduits contain a visually contrasting material comprising a reflective material to the extruded body portion; and/or the extruded body portion and/or the one or more conduits contain a substance which is at least partially luminescent; and/or the one or more conduits contains a material which is able to change colour upon variations in pH and/or temperature.

According to a third aspect of the present invention, there is provided a method of manufacturing the above mentioned confectionery product of the first aspect of the present invention, the method comprising the steps of extruding a material having a plurality of conduits disposed therein, wherein the extruded body portion is substantially transparent and the plurality of conduits comprise a visually contrasting material to the extruded body portion, wherein different conduits individually comprise different coloured substances and/or comprise substances which may vary in colour along the length of the conduits.

According to a fourth aspect of the present invention, there is provided a method of manufacturing a confectionery product according to the second aspect of the present invention, the method comprising the steps of extruding a material having one or more conduits disposed therein, wherein the extruded body portion is substantially transparent and the one or more conduits comprise a visually contrasting material comprising a reflective material to the extruded body portion; and/or the extruded body portion and/or the one or more conduits contain a substance which is at least partially luminescent; and/or the one or more conduits contains a material which is able to change colour upon variations in pH and/or temperature.

By “substantially transparent” it is meant herein that a consumer is able to see the inner one or more conduits or plurality of conduits through the extruded body and the term is intended to include materials having a slight opacity which still enables the one or more conduits or plurality of conduits to be seen through the extruded body.

By “visually contrasting” it is meant herein that the material in the one or more conduits or plurality of conduits is sufficiently visually different to the material comprising the transparent extruded outer body portion that a consumer is able to easily distinguish between the two materials with the naked eye.

The material used to produce the extruded portion may comprise a number of materials commonly use in the production of confectionery, such as candy or gum, etc.

According to one aspect of the invention, the extruded body portion is a chewing gum or a component thereof. When used herein, the term ‘chewing gum’ is intended to include chewing gum, bubble gum or gum base.

According to another aspect of the invention, the extruded body portion is a confectionery shell, typically a candy material. Suitable candy materials include hard candy, chewy candy, gummy candy, jelly candy, or toffee caramel and the like.

According to one aspect of the invention, the visually contrasting material comprises a reflective material. Such a reflective material may comprise particles or flecks which are metallic or coated with a metallic material. For example, the reflective material may be an edible glitter or gold leaf (or other inert reflective metal), or another safely consumable substance which is able to reflect light off itself and provide an attractive visual effect for a consumer.

According to another aspect of the invention, the one or more conduits or plurality of conduits may comprise one or more helical turns along the length of the conduit. Such helical turns may be produced by either rotating the extrudate during extrusion or rotating the extrusion die head during extrusion.

According to another aspect of the invention, the extruded body portion and/or the one or more conduits or plurality of conduits may contain an edible substance which is at least partially luminescent.

It will be apparent to the skilled addressee that potentially any luminescent material which is safe for human consumption may be used to produce a novel “glow in the dark” confectionery product. Luminescent nanoparticles are commercially available for use as food sensors—and such nanoparticles could be used in the present invention. Luminescent materials may be photoluminescent (ie: phosphorescent or fluorescent) or mechanoluminescent. The light generated may be after exposure to radiation, such as the confectionery product being left out in the light; or after exposure to chewing (which may result in mechanical or chemical activation).

According to another aspect of the invention, the extruded body portion may be translucent and the one or more conduits or plurality of conduits may be filled with gum components.

According to another aspect of the invention, the one or more conduits or plurality of conduits may be filled with a material which is able to change colour upon variations in pH and/or temperature.

According to another aspect of the invention, where the extruded body portion is a translucent confectionery shell, the one or more conduits or plurality of conduits are visible running throughout the shell.

According to another aspect of the invention, where the extruded body portion is a translucent gum, the extruded body portion contains filled bubbles therein.

According to another aspect of the invention, where the extruded body portion is a translucent gum, the one or more conduits or plurality of conduits are filled with a dark coloured or black edible substance which provides a stark visual contrast to the translucent gum portion.

According to another aspect of the invention, where there is a plurality of conduits, the different conduits may individually contain different coloured substances, or substances which may vary in colour along the length of the conduits.

It should be understood that the term “plurality” is intended to mean two or more. In some embodiments, a plurality is 3 or more, or 4 or more, or 5 or more, or 6 or more, or 7 or more. There is no particular upper limit on the number associated with “plurality”. In the context of the phrase “plurality of conduits”, numbers up to 50 and higher are contemplated.

It should be understood that the term “conduit” generally refers to a capillary or space created by an extrusion or other forming process within the body of the product. The conduit typically contains matter, and that matter can be in the form of a gas, a liquid, a solid, or a mixture thereof.

In the method of manufacturing the confectionery product of the invention, the steps of extruding the body portion and of extruding the one or more conduits or plurality of conduits within the body portion may be sequential, concurrent, or they may be performed on the same machine.

Where there is a plurality of conduits, the conduits may be formed substantially parallel to one another, either in a horizontal row configuration or a vertical stacked configuration. Alternatively, the conduits may be arranged in an entirely random configuration in relation to one another within the extruded body portion.

According to another embodiment, the one or more conduits or plurality of conduits may be continuous or discontinuous within the extruded body portion of the confectionery product. By this is meant that the conduits may extend most or all of the length of the extruded body portion, or that they may be interrupted such that each portion of any given conduit extends only partially along the length of the extruded body portion.

Alternatively, the one or more conduits or plurality of conduits may be bubble-like in appearance, such as substantially spherical in appearance. When filled with the visually contrasting material, they can optionally give the visual appearance of a marble, i.e. with a number of different colours simultaneously visible within the conduit.

The conduits may extend along the substantially entire length of the extruded portion, but may in some embodiments extend no less than 75%, 80%, 90%, 95% or 99% along the length of the extruded portion (for example, when it is desired to seal the ends of the extruded portion). If the conduits extend along the entire length of extruded portion, suitably the ends of the conduits are visible at one or more ends of the extruded portion.

One or more of the conduits is filled with a material which is visually different from that of the material used to form the substantially transparent extruded body portion. Different conduits may incorporate different materials if desired.

According to one embodiment, the one or more conduits or plurality of conduits may be filled with a fluid material. Such a fluid may comprise a liquid.

According to another embodiment, the one or more conduits or plurality of conduits may be filled with a material which is solid at a room temperature and fluid at a temperature greater than room temperature. For example, a molten chocolate may be incorporated into the conduits and allowed to set when cooled to room temperature. It will be apparent to the skilled addressee that room temperature is commonly regarded as around 20° C.

According to another embodiment, the one or more conduits or plurality of conduits may be filled with a material which is deposited as a liquid and which subsequently solidifies. In such embodiments, the solidification may be dependent or independent of heat. It will be apparent that solidification of a liquid filled conduit may be achieved in a number of ways. For example solidification may take place due to one or more of the following:
Cooling—the filling may be molten when deposited which then cools to a solid at room temperature;
Heating—the filling may be liquid when deposited, and the heat of the extruded body portion sets the filling (e.g. pumping egg albumen into a hot hard candy extruded body portion will set the egg on contact);
Drying—the filling may be a solution that dries into a solid (e.g. the moisture from the solution is absorbed into the extruded body portion);
Solvent loss—the filling may be in a solvent, whereby the solvent is absorbed into the extruded body portion, leaving a solid;
Chemical reaction—the filling may be deposited as a liquid but reacts or “goes off” into a solid;
Cross-linking—the filling may form a cross-linked material due to mixing and/or heating; and
Time—the filling may simply set with time (e.g. a solution of sugars and gelatin will eventually set over time).

Suitable visually contrasting filling materials for the one or more conduits or plurality of conduits include, but are not limited to, aqueous media, fats, chocolate, caramel, cocoa butter, fondant, syrups, peanut butter, jam, jelly, gels, truffle, praline, chewy candy, hard candy or any combination or mixture thereof. Other suitable visually contrasting filling materials will be readily apparent to the skilled person.

If desired, the product may further comprise a substantially transparent coating portion to envelop the extruded body portion. The skilled addressee will appreciate that a number of coatings could be employed—for example, chocolate, gum, candy and sugar etc.

It is possible to modify existing confectionery materials, which are not inherently transparent so that they can be employed in the present invention. For example, a chewing or bubble gum is not inherently transparent. However, if the body portion is made from a modified gum base which excludes binders and talcs, then an extrudable transparent body portion can be made. The components taken out of the gum base can be mixed with the remaining components of the chewing/bubble gum and included in the one or more conduits or plurality of conduits being visually contrasting. A similar approach can also be taken to modify other existing confectionery materials which are not inherently transparent, such as fat based coatings, etc.

In some embodiments, the conduits are distributed substantially uniformly throughout the extruded portion, and may be spaced evenly apart from adjacent conduits. In other embodiments, the conduits may be distributed in pre-defined configurations within the extruded portion, such as around the periphery of the extruded portion, or in groups at one or more locations within the extruded portion.

In some embodiments the extruded body portion has a circular, elliptical, regular polygonal or semi-circular cross-section. The extruded portion may be shaped in the form of a cylinder, a rope, a filament, a strip, a ribbon or the like, or may be shaped in the form of a standard confectionery product such a chocolate bar, or chewing gum slab, pellet, ball, stick or ribbon, for example. The extruded portion may be irregular or regular in shape. Furthermore, the extruded portion may be formed in potentially any shape, for example in the shape of an object, cartoon character or an animal to name but a few.

In an embodiment, the conduits in the extruded portion result in a voidage in the range of about 1-99% of the extrudate, or about 5-99% of the extrudate. The voidage may be in the range of about 10-60%, 20-50%, 30-45%, or 35-40%. The voidage may also be in intermediate points in these ranges, for example, about 5-40%, 5-45%, 5-50%, 5-60%, 10-40%, 10-45%, 10-50%, 10-99%, 20-60%, 20-45%, 20-40%, 20-60%©, 20-99%, 30-40%, 30-50%, 30-60% or 30-99%. The voidage may be over about 5%, 10%, 15%, 20%, 25%, 30%, 35%, 40%, 45%, 50%, 55%, 60%, 65%, 70%, 75%, 80%, 85%, 90% or 95%.

It should be understood that the term “voidage” generally refers to the volume percent of the conduit volume relative to the sum of the conduit volume and the extruded body portion volume. That is voidage (%)=100×conduit volume/(conduit volume+extruded body portion volume). In some embodiments, the extruded body portion volume does not include any central region volume created by certain dies, such as an annular die.

The incorporation of conduits having a small cross-sectional width or diameter enables the one or more conduits or plurality of conduits to entrain contrasting or complementary confectionery materials into the extruded portion whilst avoiding the need to incorporate large centre-fill areas which may be prone to leakage through, or out of, the confectionery product. The use of a plurality of conduits also advantageously enables two or more materials to be incorporated into the confectionery product to give multiple visual sensations, textures, tastes, colours and/or mouth-feel sensations, throughout the whole confectionery product.

In some embodiments, the conduits may have a diameter or width of no more than about 3 mm, or of about 2 mm, 1 mm, 0.5 mm, 0.25 mm or even less. It is possible to have conduits having a diameter or width as low as about 100 μm, 50 μm or 10 μm. The individual conduits may have different widths or diameters, although typically the widths or diameters are approximately the same.

The material of the body portion will preferably be liquid during extrusion. It should be understood that the term “liquid” is intended to mean that the material is capable of or has a readiness to flow, including gels, pastes and plasticized chocolate. Furthermore, this term is intended to include, but is not limited to, those materials which may be “molten” during extrusion; the skilled addressee will understand that the term “molten” means that the material has been reduced to a liquid form or a form which exhibits the properties of a liquid. The body portion may be at least partially or substantially solid, so that it can no longer be considered to flow in a liquid form.

According to a further embodiment of the invention, there is provided a confectionery product comprising a substantially transparent extruded body portion having one or more conduits or a plurality of conduits disposed therein, wherein each conduit is separated from each adjacent conduit by a wall formed from the extruded body portion and wherein the wall between each conduit has a thickness of no more than the width or diameter of the conduits, and wherein the one or more conduits or plurality of conduits comprise a visually contrasting material to the extruded body portion.

According to a further embodiment, there is provided a method for manufacturing a confectionery product comprising an extruded body portion, the extruded body portion comprising one or more conduits or plurality of conduits, wherein the extruded body portion is substantially transparent and the one or more conduits or plurality of conduits comprise a visually contrasting material to the extruded body portion, the method comprising the steps of
a) extruding an extrudable confectionery material with one or more conduits or a plurality of conduits disposed therein;
b) filling the one or more conduits or plurality of conduits with a visually contrasting material to the extruded body portion; and either
c) cutting the extrudate into two or more pieces having one or more conduits or plurality of conduits disposed therein and forming a confectionery product incorporating the pieces; or
d) folding the extrudate and forming a confectionery product incorporating the folded extrudate.

The deposition of the filling into the one or more conduits or plurality of conduits may be carried out during the step of extrusion, but may also take place after extrusion. In an embodiment, the filling comprises a fluid. The fluid may comprises a liquid, or a material which is liquid at a temperature greater than room temperature. The fluid may solidify after deposition if desired.

Any of the processes may further comprise the step of quench cooling the extrudate after extrusion. The quench cooling may utilise a fluid, such as air, an oil or liquid nitrogen, although other methods of quench cooling will also be readily apparent to the skilled addressee.

Any of the processes may further comprise the step of, after extrusion, stretching the extrudate. Stretching the extrudate may be undertaken by a number of means, for example passing the extrudate over, or through conveyor belts or rollers operating at different speeds, to stretch the extrudate. By employing this additional step, extrusions having conduits of a larger diameter can be undertaken, which diameters can be reduced gradually over time in order to produce an extrudate having smaller conduits which would have been more difficult to produce. Commonly, conduits having a bore size of about 2 mm or more will be produced during extrusion and these conduits will be reduced significantly by stretching the extrudate. In some embodiments the conduits are reduced to no more than about 1 mm, 0.5 mm, 0.25 mm, 100 μm, 50 μm, 25 μm or 10 μm.

Any of the processes may further comprise the step of enveloping the confectionery product in a substantially transparent coating. Such a coating will be apparent to the skilled addressee and is discussed previously herein.

The methods may be used for producing a confectionery material as described hereinabove.

A further embodiment of the present invention provides for apparatus which is adapted for producing a confectionery product according to the methods as herein above described. WO2005056272 discloses an apparatus for producing an extruded product including a plurality of conduit channels. WO2008044122 discloses a related apparatus, which additionally includes means for quench cooling an extrudate as it exits the die. Both of these apparatuses may be employed or adapted for use in producing the confectionery in accordance with the present invention.

### DETAILED DESCRIPTION OF THE INVENTION

Specific embodiments of the present invention will now be described, by way of example only, with reference to the accompanying drawings, in which:

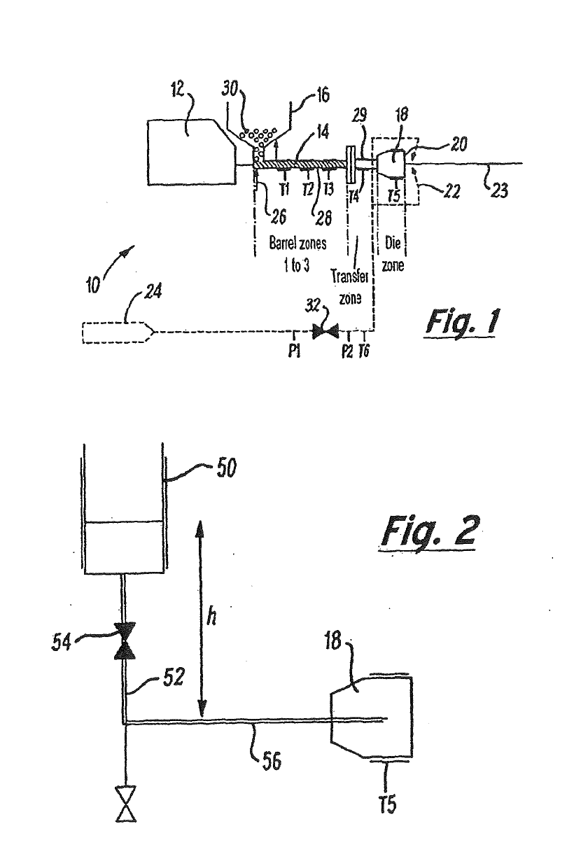

FIG. 1 is a schematic diagram illustrating the overall apparatus which can be used to make the confectionery products of the invention;

FIG. 2 is a schematic diagram illustrating an apparatus which can be used in conjunction with the apparatus shown in FIG. 1, to provide liquid filled conduits;

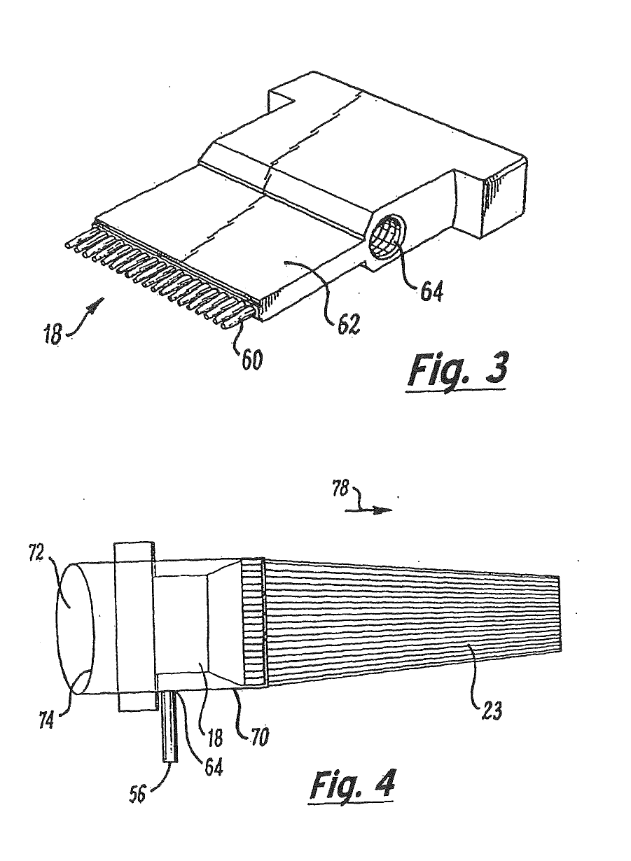

FIG. 3 is a schematic diagram illustrating an extrusion die used to form conduits in the extruded body portion material;

FIG. 4 is a plan view of the extrusion die which incorporates the extrusion die shown in FIG. 3 in the apparatus as illustrated in FIGS. 1 and 2;

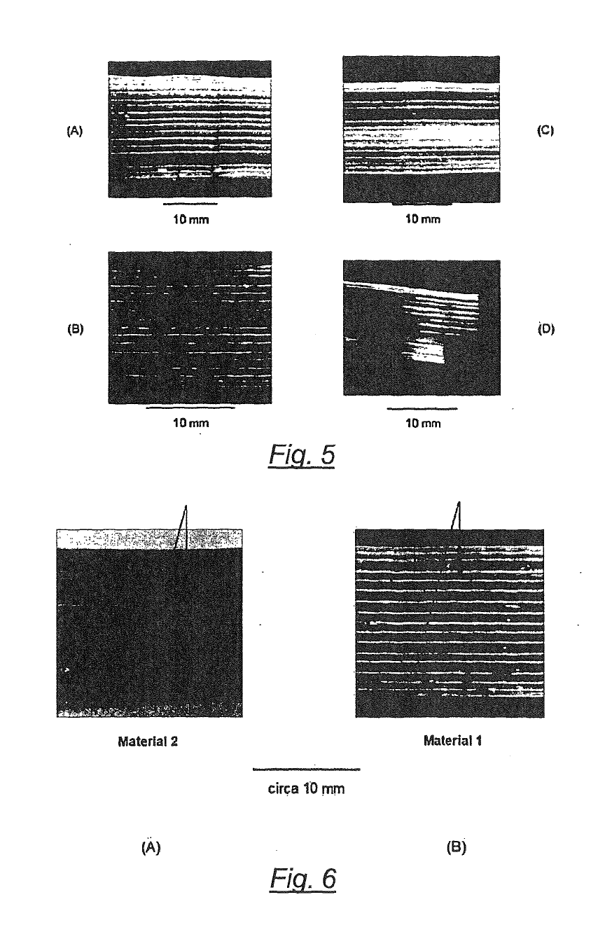

FIG. 5 shows photographs of four conduit extrudates formed from material 1 in Example 1, the photographs show: (A) low voidage, (B) and (C) high voidage and (D) very high voidage;

FIG. 6 shows photographs comparing conduit extrudates formed from (A) material 2 containing completely filled cocoa butter conduits and (B) material 1 formed with air filled conduits;

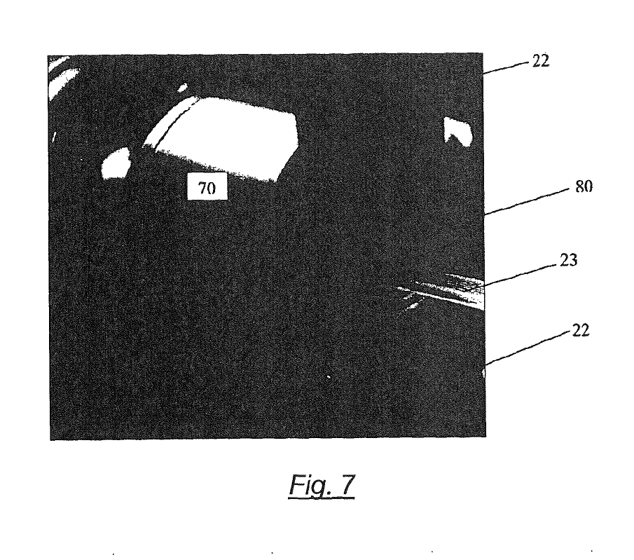

FIG. 7 shows a photograph of the external part of the extrusion apparatus as illustrated in FIGS. 1 and 2, showing the air knives used to cool the extrudate when it exist the die;

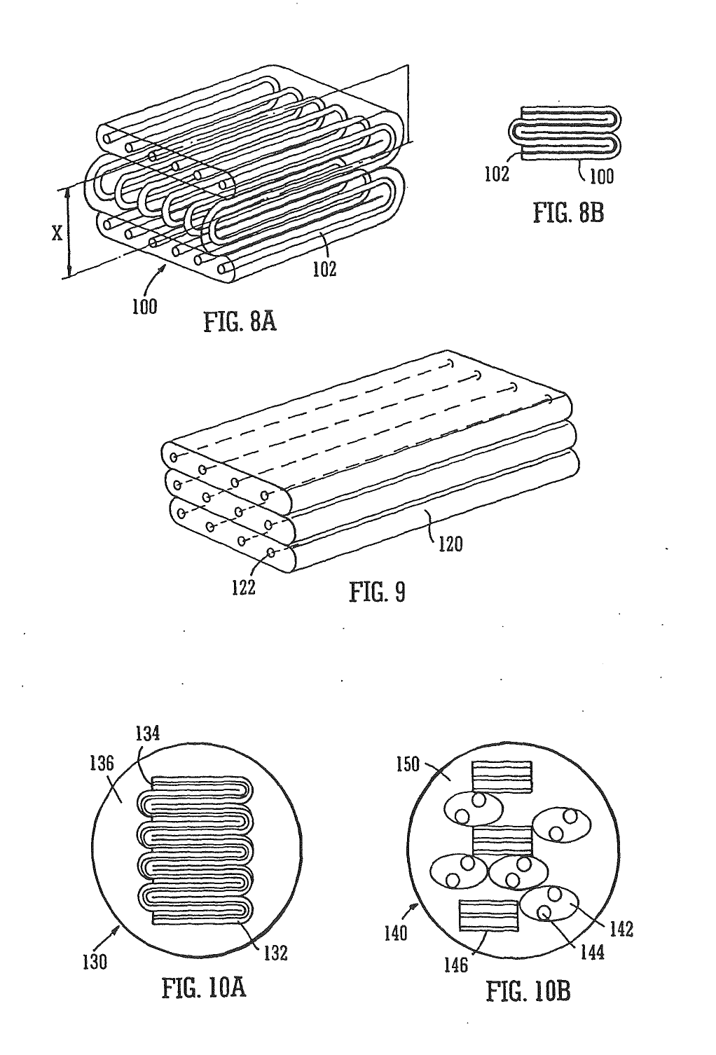

FIG. 8A shows a perspective view of an extrudate formed in accordance with the present invention, where the extrudate has been folded;

FIG. 8B shows a cross-sectional view of the extrudate as shown in FIG. 8A, viewed from the line denoted “X”;

FIG. 9 shows a perspective view of an extrudate formed in accordance with the present invention, where a number of extruded layers have been stacked upon one another;

FIG. 10A shows a schematic cross-sectional view of an embodiment of a confectionery product in accordance with the present invention, where the conduits are in a folded configuration;

FIG. 10B shows a schematic cross-sectional view of an embodiment of a confectionery product in accordance with the present invention, a number of small pieces of extruded material have been incorporated into the product in different orientations;

FIGS. 11A and 11B show an embodiment of a confectionery product in accordance with the present invention, where the conduits are arranged in a double helix. More specifically, FIG. 11A is a cross-sectional view of the product, whereas FIG. 11B is a cut-away side view;

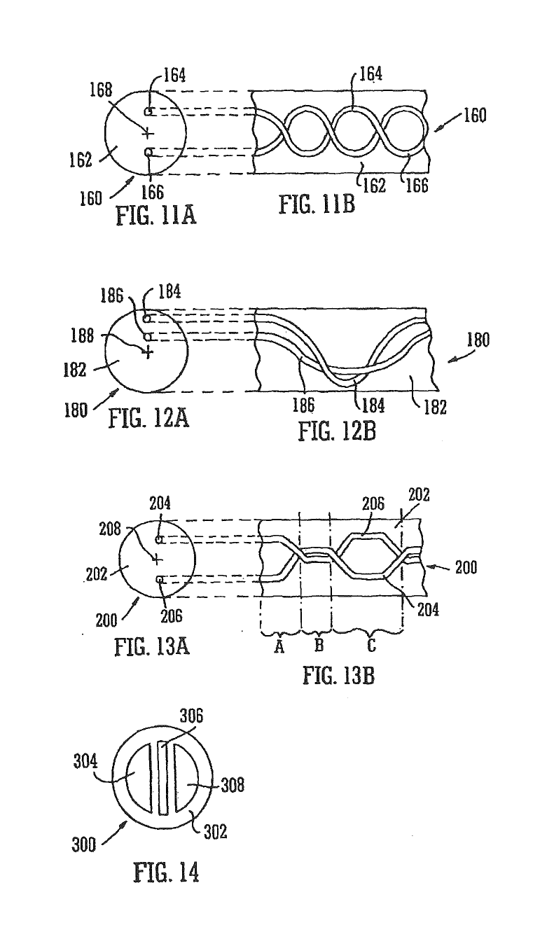

FIGS. 12A and 12B show an embodiment of a confectionery product in accordance with the present invention, where the conduits are arranged as two helical strands which run close to one another. More specifically, FIG. 12A is a cross-sectional view of the product, whereas FIG. 12B is a cut-away side view; and

FIGS. 13A and 13B show an embodiment of a confectionery product in accordance with the present invention, where the conduits are arranged in a wave pattern. More specifically, FIG. 13A is a cross-sectional view of the product, whereas FIG. 13B is a cut-away side view.

FIG. 14 shows the cross-section of an embodiment of the present invention where the finished confectionery product is in the format of a “glass marble”.

Experiments were conducted to produce a variety of confectionery products incorporating conduits. Three phases of extrusion work were undertaken using various materials. The first phase concerned the extrusion of a substantially transparent hard candy using a conduit die attached to a small-scale extruder in a non-food grade environment for creating conduit candy extrudates in both low- and high-voidage forms.

The second phase of the experimental work built upon the first phase to produce low and high voidage candy conduit extrudates containing an array of cocoa-butter filled conduits. The first and second phases are described below in Example 1. The third phase built upon the first two and recreated the working environment with food grade equipment in a food grade environment and is described below in Example 2.

### Example 1

Phase one concerned the extrusion of candy using a conduit die attached to a small-scale extruder, in order to confirm that candy having conduits with both low and high voidage values could be formed in accordance with the present invention.

The materials that were trialled during this investigation are shown in Table 1.

TABLE 1

| Material | | | |
|---|---|---|---|
| number | Material name | Majority ingredients | Application |
| 1 | Custom recipe 1 | Sugar (40%); | Extruded matrix |
| | | Glucose Syrup (60%) | |
| 2 | Custom recipe 2 | Maltitol syrup (96%); | Extruded matrix |
| | | Gum Arabic (2%); | |
| | | Water (2%) | |
| 3 | Cocoa butter | Cocoa butter (100%) | Conduit filler |

Materials 1 and 2 were supplied as large solid blocks. All materials were crushed prior to extrusion to yield a fine granular powder, with grain sizes ranging between 1 mm and 5 mm. Material 3 was supplied as a tub of solidified cocoa butter; the required quantity was broken up into a fine powder containing only small lumps before being fed into the heated cocoa butter reservoir.

The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using PID controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the conduit die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired, the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled.

In use, the hopper 16 is filled with material 30 (such as candy in solution) which can be heated so as to render it (or maintain it as) a liquid (anything other than a solid or particulate solid). Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature adjusted again (if required) by temperature control T4 before entering the die 18. The die 18 (shown in FIG. 3) has a number of needles (not shown) located within an entrainment body so that the material passes over and around the needles. At the same time that the material is being extruded, compressed air 24 is forced through the needles so that the extrudate contains a number of conduits. The extrudate 23 is cooled by means of the quench jets 22 as it is released from the die 18. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through needles, the needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the conduits formed around and the needles can be simultaneously filled with cocoa butter. Of course, the conduits can be filled with other types of visually contrasting liquid material if desired.

FIG. 3 shows the die 18 in more detail. In particular, this figure shows that the metallic die 18 has, at one end, a plurality of needles 60 which are joined to a cavity 62 which is in fluid communication with an inlet channel 64 for pumping a fluid material into the conduits of the extrusion.

With reference to FIG. 4, there is shown the die 18 in place in an entrainment body 70. Molten material 72 enters an opening 74 of the entrainment body 70 and the material is forced over and around the needles 60 of the die 18. At the same time, either air or liquid cocoa butter enters the die inlet by means of a fluid feed conduit 56. When operational, the molten material is extruded through the entrainment body 70 over the needles 60 of the die 18. Either air or cocoa butter is then pumped through the needles at the same time so as to produce an extrudate 23 (in direction 78) which either has conduits with no filling or conduits filled with cocoa butter.

FIG. 7 shows the entrainment body 70 having an opening 80, through which the extrudate is formed. This figure also shows two quench jets 22 located above and below the aperture so as to cool down the extrudate after is has been produced.

In use, the flow of molten material over the tips of the entrainment nozzles (hypodermic needles) caused a small area of low pressure to form at each needle tip. Each nozzle was connected together via internal channelling within the entrainment body. These, in turn, were connected outside the extrusion die to either air at room temperature and pressure or to a molten cocoa butter reservoir, with a hydraulic head of h in FIG. 2. The pipework connecting the die to the cocoa butter reservoir and the cocoa butter reservoir was externally heated to maintain the cocoa butter in the liquid phase. A set of isolation valves were used to switch between either using an air feed to the entrainment body or a molten cocoa butter feed. This is shown schematically in FIG. 2.

The quench jets were used for the generation of the high-voidage material.

Differential scanning calorimetry (DSC) was used to examine thermal behaviour of the materials, such that information relating to the phase transition temperatures could be obtained.

Material 1 was formed in a large solid block. The block was broken up mechanically, such that it became a granulated material with granule sizes between 1 mm and 5 mm.

The extrusion temperature profile was set to that shown in below Table 2.

TABLE 2
Extruder temperature profile for material 1

| Temperature zone | Label on FIG. 1 |
|---|---|
| Barrel zone 1 | T1 |
| Barrel zone 2 | T2 |
| Barrel zone 3 | T3 |
| Die zone 1 | T4 |
| Die | T5 |

Granulated pieces of material 1 were starve-fed into the extruder, with the extruder screw speed set to 40 rpm. The granules of material 2 conveyed well into the extruder in the solid phase initially, but due to the sticky nature of the material, some mild feed zone bridging and blocking was observed. This was overcome by gently pushing the broken-up material on to the extruder screw with a polyethylene rod.

Successful conduit extrudates were easily achievable using this protocol. The material had good melt strength and was pulled away easily from the die in the molten state before it set into a brittle, glassy, material. The glassy state of the material meant that, it was unsuitable for use in a pair of nip rolls since the compression experienced by the material in this apparatus caused fracture. Consequently, the conduit extrudates from material 1 were hand drawn, the conduits having an average diameter (width) of less than 4 mm.

Low voidage MCF from material 1 was easily obtained without quenching the extrudate using the quench jets; this is illustrated in the photograph in FIG. 5(A). Enhanced manual hauling of the extrudate away from the die exit coupled with use of the quench jets resulted in high voidage conduits being extruded. The ultimate voidage depended on the speed at which the material is hauled away from the die; various different forms of high voidage conduit extrudate formed from material 1 are shown in FIGS. 5(B), (C) and (D). Crude optical analysis of the cross section of material similar to those shown in FIGS. 10(B) and (C) revealed that voidage between 35% and 40% had been generated. It is highly likely that the high voidage material shown in FIG. 10(D) was in excess of the value of 35% or 40%.

The second phase of the of extrusion experiments were conducted with material 1 using cocoa butter heated to between 35° C. and 40° C. The head, h, of the cocoa butter reservoir was initially set to 8 cm, and material two fed into the extruder as described earlier. The initial proof of concept was successful, and resulted in the partial filling of the conduits with molten cocoa butter. It was observed, however, that due to the increased viscosity of the cocoa butter compared to air, the rate at which cocoa butter could be entrained into the extrudate was slow. This problem appeared to be solved by increasing the head of the reservoir to 21.5 cm. It was also observed qualitatively that, in low voidage form, the cocoa-butter filled conduits appeared somewhat smaller than their air-filled counterparts (less than 3 mm compared to less than 4 mm). It was also possible to create high-voidage cocoa-butter filled conduit extrudates, subject to the coca-butter head being high enough to supply molten cocoa butter at the increased rate.

Material 1 was successfully formed into conduit extrudates, of both high and low voidage, with either air-filled conduits or cocoa butter-filled conduits. Varying different voidages films were made, and it was observed that increasing levels of voidage led to increasing fragility. A representative figure for one of the high voidage air-cored films was between 35% and 40% and it is estimated that the very high voidage, highly fragile films, exceeded this.

Material 2 was formed from a mixture of 96% maltitol syrup, 2% gum arabic, and 2% water. Material 2 was shown to act in a similar manner to material 1, in that it was supplied in a large block that was required to be broken up mechanically into smaller granules before it could be fed into the extrusion line. Prior to extrusion experiments commencing, the extrusion die was disassembled and washed and the extruder was fed a hot water wash to dissolve any material 1 remaining within the extruder barrels or on the screw. After the water was purged from the extruder, the extruder was heated to 130° C. for between five and ten minutes to evaporate any remaining water. An early scoping experiment revealed that material 2 required higher extrusion temperatures than material 1; the final extrusion line temperature profile is shown in Table 3 below.

TABLE 3
Extruder temperature profile for material 2

| Temperature zone | Label on FIG. 1 | Temperature (° C.) |
|---|---|---|
| Barrel zone 1 | T1 | 115 |
| Barrel zone 2 | T2 | 115 |
| Barrel zone 3 | T3 | 115 |
| Die zone 1 | T4 | 115 |
| Die | T5 | 120 |

As with material 1, material 2 was starve-fed into the extruder. As with material 1, the screw speed was set to 40 rpm. Material 2 proved to be easy to extrude and conduit extrudates with air-filled conduits were produced in both low and high voidage forms. Material 2 exhibited good melt strength, good drawing characteristics prior to solidifying and became brittle and glassy upon solidification. Again, this precluded the use of nip rollers to draw the material from the die and control the amount of draw down achieved, hence manual drawing was used in a similar way to material 1. In terms of restarting the extrusion line after an idle period, material 2 did not prove to be noticeably different to material 1, and the line restarted relatively easily. Due to the ease with which conduit extrudates were achieved, phase one was concluded relatively quickly to allow progression to phase two.

Phase two experiments were conducted with material 2 using cocoa butter heated to between 35° C. and 40° C. The head, h, of the cocoa butter reservoir was kept at 21.5 cm, and material 2 starve-fed into the extruder as described in the previous section. Successful extrusion of both low- and high-voidage micro conduit extrudate from material 2 containing completely filled cocoa-butter conduits was achieved. A photograph comparing the cocoa-butter filled conduits of material 2 to the air filled conduits of material 1 is shown in FIG. 6. Crude optical analysis of a cross section of a piece of high-voidage material 2 revealed that the voidage was roughly 35% at minimum. It is likely this figure can be easily increased through optimisation of the protocol.

The observations for material 2 are similar to those from material 1. Low- and high-voidage conduit extrudates were formed, either containing cocoa-butter conduits or air-filled conduits. Crude optical analysis of a moderately high-voidage extrudate revealed that the void fraction was approximately 35%, although it is thought that the actual figure may have been higher. Increasing product voidage again led to increasing product fragility due to the conduit walls becoming very thin.

The objectives of these first and second phase experiments were to provide proof-of-concept for the extrusion of conduit extrudates from various candy materials. This was successful with both materials (material 1=40% sugar and 60% glucose, and material 2=96% maltitol syrup, 2% gum Arabic and 2%© water). Low- and high-voidage conduit extrudates were formed containing both air-filled conduits and cocoa-butter filled conduits. It was estimated that a typical high-voidage extrudate contained roughly 35% to 40% voidage whether it was air filled or cocoa-butter filled.

### Example 2

The third phase built upon the first two phases described in Example 1 and recreated the working environment with food grade equipment in a food grade environment. This food-grade setup extruded hard candy, chocolate and chewing gum with air, liquid and solid centres. This range of filled extrudates was made in a food grade environment and the extrudates were consumed to investigate their edible properties.

The following edible materials were used in these experiments:

Chewing gum (uncoated Peppermint-Spearmint Higher flavour chewing gum pellets); hard candy, mint candy (Extra Strong Mints®, Jakemans® Old Favourites), fruit candy (Summer Fruits, Jakemans® Old Favourites), chocolate (milk chocolate (with 0, ½, 1, 2% added water), Cadbury® Dairy Milk® Buttons—when used molten, 2% PGPR was added to lower the melt viscosity for ease of use (c.f. legal limit of ½%)), compound chocolate (Plain Belgian Chocolate, SuperCook®), 72% Cook's Chocolate, Green & Black's®. Liquid fillings used in these experiments included: monopropylene glycol (Propane-1,2-diol, BP, EP, USP, Fisher Scientific®—selected for low viscosity, zero moisture, low flavour, and BP, EP & USP grade for oral use), Golden Syrup (partially inverted refiners syrup—Tate & Lyle®—selected for higher viscosity, food grade, shelf stability, and sweet flavour), Red Food Colouring (SuperCook®, UK), Blue Food Colouring (SuperCook®, UK). Lastly, a solid filling of cocoa butter obtained internally from a Cadbury Plc. site was also used in these experiments and this was selected because it is solid at room temperature and has low hot viscosity.

A Davis-Standard HPE-075 ¾″ 24:1 single-screw extruder was used in these experiments. The extruder also included air-knives and a header tank. The screw was a simple conveying-compression-pumping all forward element design, with no mixing or reversing sections. The motor was 3 KW, geared to produce 0-100 rpm screw rotation. The feed throat was jacketed and supplied with flowing ambient water to prevent heat transfer from the barrel causing feed problems with sticky feedstuff. The barrel had three heating zones, each with a 1 KW heater and forced ambient air cooler. The standard extruder has a Eurotherm 3216 controller per barrel zone and one spare for the die (die controller connected to thermocouple input and standard 16A 240V socket for up to 1 KW heater output).

At point of purchase, two additional die controllers, thermocouple inputs and heater outputs were specified to enable integrated control of the header tank containing filling material and the pipework connecting that header tank to the die. The die was an assembly of parts comprising a body with main die orifice of long thin rectangular shape, through which 19 interconnected nozzles (similar in size to hypodermic needles) also exited. The main body was heated and the nozzles led to an external fitting that could be opened to ambient air or could be connected to the heated, pressurized header tank. A bobbin shaped flange was constructed to mount the die assembly onto the extruder end flange.

The die was heated with 4×100 W ¼″ cartridge heaters, and monitored by a K-type thermocouple probe. Initially these were controlled by a Eurotherm 3216 in a bespoke enclosure until the control and power wiring was transferred to a Eurotherm integrated into the extruder. The die assembly was earthed into the power outlet from the extruder.

The header-tank and the pipework connecting the header tank to the die were heated with two 100 W ribbon heaters initially controlled from a single analogue controller in a bespoke enclosure, and monitored by a single bare K-type thermocouple. These were later separated to two Eurotherm 3216s integrated into the extruder with two thermocouples and two power supplies. The header tank was earthed to the power outlet, whilst the pipework was plastic and did not need to be earthed.

Compressed air, BOC®, UK was regulated with series 8000 gas regulator and pressures used were 0-10 bar. The main use for the compressed air was to supply the air-knives.

Food Safe High-Tech Grease, and Food Safe Penetrating Oil from Solent Lubricants, Leicester, UK were used.

The conduit die was connected on the extruder endplate. Two opposed air knives were used to rapidly quench the extrudate emerging from the extrusion die, were placed above and below the die exit; these jets were connected via a valve to a compressed air line at 10 bar pressure. A schematic diagram showing the general layout of the extrusion line is shown in FIG. 1.

In use, the flow of molten material over the tips of the entrainment nozzles (hypodermic needles) caused a small area of low pressure to form at each needle tip. Each nozzle was connected together via internal channelling within the entrainment body. This, in turn, was connected outside the extrusion die to either air at room temperature and pressure or to a header tank containing a liquid that was at ambient or elevated temperature and pressure, with a hydraulic head of h. The header tank and the pipework connecting to the die were externally heated. A set of isolation valves were used to switch between either using an air feed to the entrainment body or a molten cocoa butter feed. This is shown schematically in FIG. 2.

The quench jets were used for the generation of the high-voidage material. It had been found during previous research that if the emerging extrudate was quenched very rapidly and subjected to a high drawing force, a higher voidage cross section could be obtained. Adjustment of the polymer and process conditions yielded voidages up to, and possibly in excess of, 60%.

Hard candy was pre-broken before introduction to the extruder. Particle size was not important—the extruder was found to take whole candies or dust. It was found that broken candies fed more evenly than whole pieces. All barrels and the die were set to 95° C. for fruit candy. Mint candy had tolerance to a wide range of temperatures and could run with barrels and die at 95°-110° C.

Screw speeds of 15-100 rpm were used in the experiments. Differences in product were minimal (except rate of production). Continuous, complete, transparent films with well formed conduits could be produced optimisation of the protocol. The films could be filled and/or drawn without leaking. Product morphology was found to change with drawing speed and rate of cooling inline. Fast drawing with no cooling could thin the films to 1 mm wide with microscopic width and conduits. Drawing with heavy cooling enlarged the voidage in the films.

In another test, uncoated gum pellets were reduced in size to approximately 3 mm to aid feeding into the extruder. This was done with freezing and a domestic food processor. Barrel and die temperatures of 58° C. resulted in the most contiguous product. This product had sufficient integrity to be filled with few leaks. It is likely that using gum base, in particular molten gum base, rather than whole gum would produce films with even greater integrity.

In a further test, chocolate was used as material for extrusion. To gain stable running conditions, the heaters and cooling fans of the extruder were electrically disabled. Direct temperature control was abandoned in favour of relying on the air conditioning of the laboratory. With these modifications the extruder barrel indicated an even 22° C. and it was simple to extrude conduit chocolate in a steady state using molten tempered Cadbury's Dairy Milk® chocolate.

As with hard candy extrusion, it was possible to draw the chocolate extrudate so as to alter the cross sectional geometry, and produce conduits having diameters or widths of between 0.5 mm and 4 mm.

Air filling was achieved through a simple ambient air-bleed to the nozzles in the die and a cross section of the extrudate is shown in FIG. 8.

Monopropylene glycol filling was achieved at ambient temperature and pressure, with approximately 5 cm liquid depth in the header tank which was in turn approximately 10 cm higher than the die. Colour was added directly into the header tank as and when required.

Golden Syrup filling was achieved by heating the header tank and pipework to 78° C. to fill hard candy, and 58° C. to fill gum. Pressurisation of the header tank was required at the lower temperature to generate syrup flow. Again, colour was added directly into the header tank as and when required.

Confectionery products and methods of the invention have been shown for chocolate, hard candy and gum. The experiments of the third phase had shown a range of food materials that can also be used. It could therefore be deduced that any product normally solid at room temperature yet extrudable at elevated temperature and pressure could be formed into a conduit product such as chewy, gummy or jelly candies, for example. Products that show high extensional viscosity when warm may be drawn to alter their geometry and their outer to inner ratio.

It has also been shown that liquid and solid centres can be incorporated into conduit extrusions, providing the solid centre can be liquefied and is flowable.

The extrudates of the present invention could be configured in a number of ways. For example, FIGS. 8A and 8B show a transparent candy extrudate 100 having coloured centre filled conduits 102, where the extrudate is folded back on it self several times. Such a configuration would enable an extended release of the coloured centre fill during chewing.

FIG. 9 shows multiple layers of transparent extrudate 120 being stacked on top of one another and each stack having a plurality of coloured conduits 122 containing a centre filling. Such an arrangement could also be employed as a chewy confectionery if desired.

FIG. 10A shows a cross-section of an embodiment of a confectionery product 130, where the conduits are in a folded configuration. The confectionery product is formed of a folded extruded transparent portion 132 having a number of coloured conduits 134 extending the length of the extruded portion. The conduits 134 are filled, during extrusion, with a visually contrasting liquid fill material. The extruded portion is covered by a transparent sugar coating 136. When the product is consumed, the liquid filled material is released gradually form the conduits 134 as they are punctured and/or the material used for the confectionery and coating is degraded.

FIG. 10B shows a cross-section of an embodiment of a confectionery product 140, where a number of small pieces of extruded material have been incorporated into the product in different orientations. The confectionery product is formed with a number of individual pieces of extruded portions being oriented randomly throughout the product. The confectionery product 140 is shown having three differently orientated extruded portions: a first extruded portion 142 is shown “head on” where the contrasting conduits 144 can be seen; a second extruded portion 146 is shown “side on” where the contrasting conduits can be seen. The conduits 144 are filled with a liquid fill and the pieces are located within a transparent hard sugar candy matrix 150. Again, when the product is consumed, the liquid filled material is released gradually form the conduits 144 as they are punctured and/or the material used for the confectionery and candy matrix is degraded.

With reference to FIGS. 11A and 11B, there is shown a confectionery product 160 which is formed of a transparent extruded hard candy body 162 having a generally cylindrical configuration. Two conduits 164 and 166 containing an edible glitter 167 in a transparent syrup, are provided within the body 162, and these extend longitudinally through the body following a helical path. Whilst both conduits 164,166 extend along two separate helical paths, they are maintained equidistant from one another during the helical turns and are exactly one half turn offset from one another. The helical path of the conduits are formed by either rotating the extrudate relative to the extrusion die head, or rotating the conduit die head about the axis 168 during extrusion. The conduits 164,166 are located opposite to one another in opposing planes extending away from the axis 168. The glitter 167 in the conduits result in an attractive confectionery product which “shimmers” in the light. If desired, the product could be formed into a “candy cane” type product.

With reference to FIGS. 12A and 12B there is shown a confectionery product 180 formed of a transparent extruded hard candy body 182 having a generally cylindrical configuration. Two conduits 184 and 186 extend longitudinally through the body following a helical path. Both helices follow similar paths about a central axis 188, and the conduits are located on the same plane extending away from the axis 188. The conduits 184, 186 contain differently coloured condants which can be clearly seen through the transparent candy body 182. The first conduit 184 contains a green fondant, whereas the second conduit 186 contains a red fondant. The visually contrasting liquid fondants can be inserted into the conduits during extrusion.

Lastly, referring to FIGS. 13A and 13B, there is shown a confectionery product 200 which is formed of a transparent extruded hard candy body 202 having a generally cylindrical configuration. Two conduits 204 and 206 are provided within the body 202, which extend longitudinally through the body following a wave pattern formed of portions of helical turns (denoted A and C) which are interspersed with lateral planar sections (denoted B). The conduits 204, 206 contain different coloured syrups which, whilst transparent to some degree, are visually contrasting and can be clearly seen through the transparent candy body 202. The first conduit 204 contains a pink syrup, whereas the second conduit 206 contains a blue syrup. Whilst both conduits extend along two separate paths, they are maintained equidistant from one another during the helical turns and planar sections and they are exactly one half turn offset from one another. The conduits are located opposite to one another and extend away from a central axis 208 in opposing directions. The helical parts (A and C) are formed by either rotating the extrudate relative to the die head, or rotating the die head during extrusion, whilst the planar sections (B) are fowled by preventing the rotation. The visually contrasting liquid syrup can be inserted into the conduits during extrusion.

With reference to FIG. 14, a confectionery product 300 is shown which looks similar to a “glass marble”. The product 300 is formed with a transparent extruded shell 302 having three conduits 304, 306 and 308. Each conduit contains a differently coloured fondant. The first conduit 304 contains a green fondant, the second conduit 306 contains a blue fondant and the third conduit 308 contains a red fondant. The product 300 is made by extruding a long rope of material having three conduits and cutting the rope into small sections before passing the pieces to a ball-forming apparatus. The act of cutting the rope nips the conduits so that the extruded body 302 extends all around the ends of the conduits to prevent any leakage. Although the body portion and conduits may be depicted as uniform in shape and pattern in some embodiments described herein, it should be understood that the body portion and/or the conduits may be non-uniform in some embodiments. There may be variations in the overall dimensions of the product, such as, for instance, the dimensions of the body portion, the conduits, the wall thicknesses between each conduit and the outer wall thickness of the product. For example, in some embodiments, the mechanical process of extrusion and optional further manipulation of the extrudate, such as stretching, may create non-uniformities in the dimensions of the product. Such processes also may create random variations in the positioning of the conduits. The conduits accordingly may be irregularly positioned in some embodiments. In addition, the capillaries may be symmetrically disposed in the body portion or asymmetrically disposed in the body portion. In some embodiments, one group of conduits may be symmetrically disposed and another group of conduits may be asymmetrically disposed in the body portion.

It is of course to be understood that the present invention is not intended to be restricted to the foregoing examples which are described by way of example only.

1. A confectionery product comprising an extruded body portion, the extruded body portion comprising a plurality of conduits disposed therein, wherein the extruded body portion is substantially transparent and the plurality of conduits contain a visually contrasting material to the extruded body portion, wherein different conduits individually comprise different coloured substances and/or comprise substances which may vary in colour along the length of the conduits, and wherein the plurality of conduits are visible through the extruded body portion.

2. A confectionery product according to claim 1, wherein the extruded body portion comprises chewing gum or component thereof.

3. A confectionery product according to claim 1, wherein the extruded body portion comprises a confectionery shell.

4. A confectionery product according to claim 1, wherein the plurality of conduits are continuous or discontinuous within the extruded body portion of the confectionery product.

5. A confectionery product according to claim 1, wherein the visually contrasting material comprises a reflective material.

6. A confectionery product as claimed in claim 5, wherein the reflective material comprises particles or flecks which are metallic or coated with a metallic material.

7. A confectionery product according to claim 1, wherein the plurality of conduits comprise one or more helical turns along the length of the conduit.

8. A confectionery product according to claim 1, wherein the extruded body portion and/or the plurality of conduits contain a substance which is at least partially luminescent.

9. A confectionery product according to claim 1, wherein the plurality of conduits is substantially filled with gum material.

10. A confectionery product according to claim 1, wherein the plurality of conduits contains a material which is able to change colour upon variations in pH and/or temperature.

11. A confectionery product according to claim 1, wherein when the extruded body portion is a gum material, the plurality of conduits therein comprise bubbles which are substantially filled with a visually contrasting material.

12. A confectionery product according to claim 1, wherein when the extruded body portion comprises a translucent gum material, the plurality of conduits are filled with a dark coloured or black edible substance.

13. A confectionery product as claimed in claim 1, wherein the conduits extend substantially parallel to one another in the body portion.

14. A confectionery product according to claim 1, wherein each conduit is separated from each adjacent conduit by a wall formed from the extruded body portion and wherein the wall between each conduit has a thickness of no more than the width or diameter of the conduits.

15. A confectionery product comprising an extruded body portion, the extruded body portion comprising one or more conduits disposed therein, wherein the extruded body portion is substantially transparent and the one or more conduits contain a visually contrasting material comprising a reflective material to the extruded body portion; and/or the extruded portion and/or the one or more conduits contain a substance which is at least partially luminescent; and/or the one or more conduits contains a material which is able to change colour upon variations in pH and/or temperature, and wherein the one or more conduits are visible through the extruded body portion.

16. A confectionery product according to claim 15, wherein the extruded body portion comprises chewing gum or component thereof.

17. A confectionery product according to claim 15, wherein the extruded body portion comprises a confectionery shell.

18. A confectionery product according to claim 15, wherein the one or more conduits are continuous or discontinuous within the extruded body portion of the confectionery product.

19. A confectionery product as claimed in claim 15, wherein the reflective material comprises particles or flecks which are metallic or coated with a metallic material.

20. A confectionery product according to claim 15, wherein the one or more conduits comprise one or more helical turns along the length of the conduit.

21. A confectionery product according to claim 15, wherein the one or more conduits is substantially filled with gum material.

22. A confectionery product according to claim 15, wherein when the extruded body portion is a gum material the one or more conduits therein comprise bubbles which are substantially filled with a visually contrasting material.

23. A confectionery product according to claim 15, wherein when the extruded body portion comprises a translucent gum material, the one or more conduits are filled with a dark coloured or black edible substance.

24. A confectionery product according to claim 15, wherein there is a plurality of conduits.

25. A confectionery product according to claim 24, wherein different conduits individually comprise different coloured substances and/or comprise substances which may vary in colour along the length of the conduits.

26. A confectionery product as claimed in claim 2, wherein the extruded body portion comprises gum base or components thereof and the one or more conduits contain other/the remaining components of chewing gum.

27. A method of manufacturing a confectionery product according to claim 1, the method comprising the steps of extruding a material having a plurality of conduits disposed therein, wherein the extruded body portion is substantially transparent and the plurality of conduits comprise a visually contrasting material to the extruded body portion, wherein different conduits individually comprise different coloured substances and/or comprise substances which may vary in colour along the length of the conduits.

28. A method of manufacturing a confectionery product according to claim 15, the method comprising the steps of extruding a material having one or more conduits disposed therein, wherein the extruded body portion is substantially transparent and the one or more conduits comprise a visually contrasting material comprising a reflective material to the extruded body portion; and/or the extruded body portion and/or the one or more conduits contain a substance which is at least partially luminescent; and/or the one or more conduits contains a material which is able to change colour upon variations in pH and/or temperature.

29. A method according to claim 27, comprising the steps of:
i) extruding an extrudable confectionery material with one or more conduits or a plurality of conduits disposed therein;
ii) filling the one or more conduits or plurality of conduits with a visually contrasting material to the extruded body portion; and either
iii) cutting the extrudate into two or more pieces having one or more conduits or plurality of conduits disposed therein and forming a confectionery product incorporating the pieces; or
iv) folding the extrudate and forming a confectionery product incorporating the folded extrudate.

30. A method according to claim 27, wherein the steps of extruding the body portion and of extruding the one or more conduits or plurality of conduits within the body portion are sequential.

31. A method according to claim 27, wherein the steps of extruding the body portion and of extruding the one or more conduits or plurality of conduits within the body portion are concurrent.

32. A method according to claim 27, wherein the steps of extruding the body portion and of extruding the one or more conduits or plurality of conduits within the body portion are performed on the same machine.

33. A method according to claim 27, wherein the extruded body portion, or one or more conduits, or plurality of conduits is rotated during extrusion.

34-35. (canceled)
